(19) United States
(12) Patent Application Publication
(10) Pub. No.: US 2025/0102025 A1
(43) Pub. Date: Mar. 27, 2025

(54) CALIPER BRAKE

(71) Applicant: HL MANDO CORPORATION, Pyeongtaek (KR)

(72) Inventor: Hatem SHAHIN, Pfaffenhofen (DE)

(21) Appl. No.: 18/607,582

(22) Filed: Mar. 18, 2024

(30) Foreign Application Priority Data
Sep. 27, 2023 (DE) 102023209445.2

(51) Int. Cl. F16D 55/226; F16D 55/00; F16D 55/228; F16D 65/18; F16D 123/00

(52) U.S. Cl. CPC F16D 55/226; F16D 55/228; F16D 65/183; F16D 2055/0066; F16D 2055/0091; F16D 2123/00

(57) ABSTRACT

A caliper brake includes: a brake disc; an inner brake pad positioned to an inner side of the brake disc; an outer brake pad positioned to an outer side of the brake disc; a first pressing member configured to press the inner brake pad toward the brake disc; a housing including a finger portion configured to press the outer brake pad toward the brake disc with a reaction force caused by a pressing force from the first pressing member; a second pressing member neighboring the first pressing member and configured to operate independently from the first pressing member to press the inner brake pad toward the brake disc; and a third pressing member being opposite to the second pressing member with the brake disc interposed therebetween and configured to operate independently from the first pressing member to press the outer brake pad toward the brake disc.

### CROSS-REFERENCE TO RELATED APPLICATION

This application claims the benefit of German Patent Application No. 102023209445.2, filed on Sep. 27, 2023 in the German Patent Office (DPMA), the disclosures of which are incorporated herein by reference in its entirety.

### BACKGROUND

### 1. Technical Field

The disclosure relates to a caliper brake, and more particularly, to a caliper brake with an improved structure of a pressing member.

### 2. Description of the Related Art

In general, a caliper brake mounted on a vehicle is equipment for decelerating the vehicle during driving, stopping the vehicle, or maintaining a stopped state of the vehicle, and obtains a braking force by strongly pressing the brake disc rotating together with the wheel with pads from both sides.

Generally, the caliper brake includes a caliper housing in which a pressing member (for example, a piston) moving back and forth by braking hydraulic pressure is installed, a carrier including a pair of brake pads and fixed to a vehicle body, and an actuator for converting a rotational force generated by a motor into linear motion to press the piston.

The brake disc is positioned between the pair of brake pads, and the pair of brake pads includes an inner brake pad and an outer brake pad, wherein friction pads are respectively attached to the inner sides of the inner brake pad and the outer brake pad.

### SUMMARY

It is an embodiment of the disclosure to provide a caliper brake capable of selectively or simultaneously performing a first braking mode by a first pressing member and a finger portion and a second braking mode by a second pressing member and a third pressing member.

It is an embodiment of the disclosure to provide a caliper brake having an advantage compared to existing techniques that implement only the first braking mode.

It is an embodiment of the disclosure to provide a caliper brake having an advantage compared to existing other techniques that implement only the second braking mode.

Additional aspects of the disclosure will be set forth in part in the description which follows and, in part, will be obvious from the description, or may be learned by practice of the disclosure.

In accordance with an aspect of the disclosure, a caliper brake includes: a brake disc configured to rotate together with a wheel; an inner brake pad positioned to an inner side of the brake disc; an outer brake pad positioned to an outer side of the brake disc; a first pressing member configured to press the inner brake pad toward the brake disc; a housing including a finger portion configured to press the outer brake pad toward the brake disc with a reaction force caused by a pressing force from the first pressing member; a second pressing member neighboring the first pressing member and configured to operate independently from the first pressing member to press the inner brake pad toward the brake disc; and a third pressing member being opposite to the second pressing member with the brake disc interposed therebetween and configured to operate independently from the first pressing member to press the outer brake pad toward the brake disc.

The first pressing member may press a larger area than the second pressing member.

The first pressing member may press a center portion of the inner brake pad.

The second pressing member may be biased in one direction with respect to the first pressing member.

The second pressing member may press a same area as the third pressing member.

The second pressing member may be coaxial with the third pressing member.

The housing may include a first cylinder in which the first pressing member moves back and forth, a second cylinder in which the second pressing member moves back and forth, and a third cylinder in which the third pressing member moves back and forth.

The caliper brake may further include a controller configured to control operations of the first pressing member, the second pressing member, and the third pressing member.

The inner brake pad may include a first inner brake pad and a second inner brake pad that is separated from the first inner brake pad, and the outer brake pad may include a first outer brake pad and a second outer brake pad that is separated from the first outer brake pad.

The first inner brake pad may be pressed toward the brake disc by the first pressing member, and the second inner brake pad may be pressed toward the brake disc by the second pressing member.

The first outer brake pad may be pressed toward the brake disc by the finger portion, and the second outer brake pad may be pressed toward the brake disc by the third pressing member.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is an orthographic projection view showing a caliper brake according to an embodiment when a housing is omitted;

FIG. 2 is a cross-sectional view showing an example of a section A, taken along line X-O of FIG. 1;

FIG. 3 is a cross-sectional view showing an example of a section B, taken along line Y-O of FIG. 1;

FIG. 4 is an orthographic projection view showing a caliper brake according to another embodiment when a housing is omitted;

FIG. 5 is a cross-sectional view showing an example of a section A′, taken along line X′-O′ of FIG. 4; and

FIG. 6 is a cross-sectional view showing an example of a section B′, taken along line Y′-O′ of FIG. 4.

### DETAILED DESCRIPTION OF EMBODIMENTS

Like reference numerals refer to like elements throughout the specification. This specification does not describe all the elements of the embodiments, and duplicative contents between general contents or embodiments in the technical field to which the present disclosure belongs will be omitted. The terms ‘part,’ ‘module,’ ‘member,’ and ‘block’ used in this specification may be embodied as software or hardware, and it is also possible for a plurality of ‘parts,’ ‘modules,’ ‘members,’ and ‘blocks’ to be embodied as one component, or one ‘part,’ ‘module,’ ‘member,’ and ‘block’ to include a plurality of components according to embodiments.

Throughout the specification, when a part is referred to as being ‘connected’ to another part, it includes not only a direct connection but also an indirect connection, and the indirect connection includes connecting through a wireless network.

Also, when it is described that a part ‘includes’ a component, it means that the part may further include other components, not excluding the other components unless specifically stated otherwise.

Throughout the specification, when a member is described as being ‘on’ another member, this includes not only a case in which the member is in contact with the other member but also a case in which another member is present between the two members.

The terms ‘first,’ ‘second,’ etc. are used to distinguish one component from another component, and the components are not limited by the above-mentioned terms.

The singular forms ‘a,’ ‘an,’ and ‘the’ include plural referents unless the context clearly dictates otherwise.

In each operation, an identification numeral is used for convenience of explanation, the identification numeral does not describe the order of the operations, and each operation may be performed differently from the order specified unless the context clearly states a particular order.

Hereinafter, an operation principle and embodiments of the disclosure will be described with reference to the accompanying drawings.

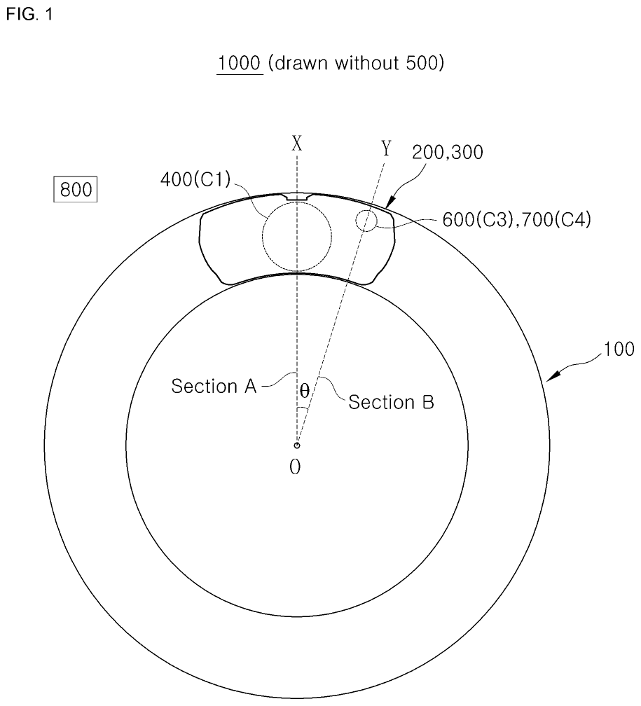

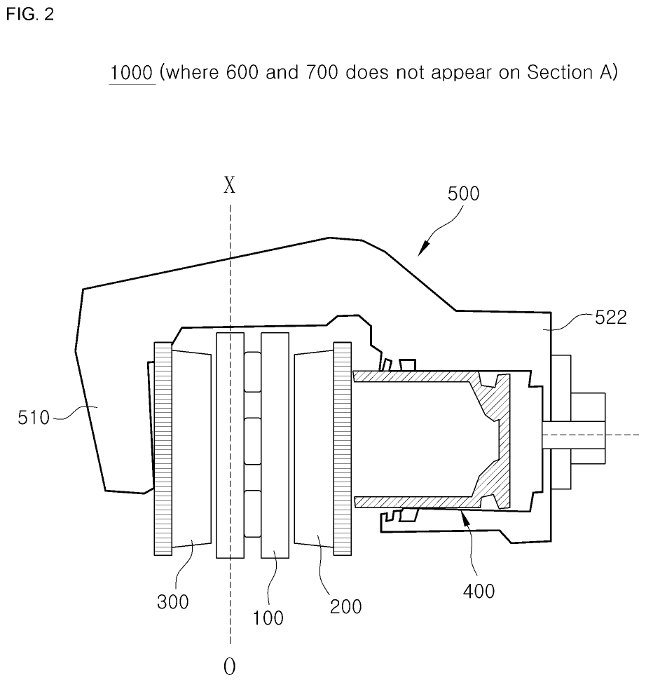

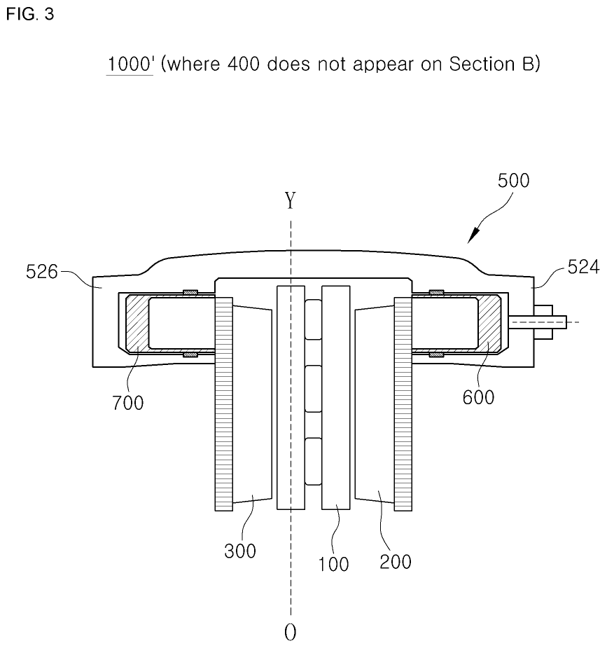

FIG. 1 is an orthographic projection view showing a caliper brake according to an embodiment when a housing is omitted. FIG. 2 is a cross-sectional view showing an example of a section A, taken along line X-O of FIG. 1. FIG. 3 is a cross-sectional view showing an example of a section B, taken along line Y-O of FIG. 1.

Referring to FIGS. 1 to 3, a caliper brake 1000 according to an embodiment may include a brake disc 100, an inner brake pad 200, an outer brake pad 300, a first pressing member 400, a housing 500, a second pressing member 600, a third pressing member 700, and a controller 800.

The brake disc 100 may rotate together with a wheel (not shown).

The inner brake pad 200 may be positioned to an inner side of the brake disc 100. The inner side of the brake disc 100 may mean an inner side of a vehicle in which the caliper brake 1000 is installed.

The outer brake pad 300 may be positioned to an outer side of the brake disc 100. The outer side of the brake disc 100 may mean an outer side of the vehicle in which the caliper brake 1000 is installed.

The first pressing member 400 may press the inner brake pad 200 toward the brake disc 100. The inner brake pad 200 may include a first contact portion C1 that contacts the first pressing member 400. The first contact portion C1 may be a portion where a first pressure distribution is formed when the first pressing member 400 contacts the inner brake pad 200.

According to an embodiment, the first contact portion C1 may have a circular shape.

The housing 500 may include a finger portion 510. The finger portion 510 may press the brake pad 300 toward the brake disc 100 with a reaction force caused by a pressing force from the first pressing member 400. In this case, a carrier (not shown) may be provided in the caliper brake 1000, and the housing 500 may slide on the carrier to move back and forth with respect to the carrier. A method in which the housing 500 moves back and forth with respect to the carrier has been widely known, and accordingly, detailed descriptions thereof will be omitted.

Meanwhile, the housing 500 is not shown in FIG. 1. However, the housing 500 will be sufficiently understood based on FIGS. 2 and 3.

The second pressing member 600 may neighbor the first pressing member 400 and operate independently from the first pressing member 400 to press the inner brake pad 200 toward the brake disc 100. The inner brake pad 200 may include a second contact portion C2 that contacts the second pressing member 600. The second contact portion C2 may be a portion where a second pressure distribution is formed when the second pressing member 600 contacts the inner brake pad 200.

According to an embodiment, the second contact portion C2 may have a circular shape.

According to an embodiment, the first pressing member 400 may press a larger area than the second pressing member 600. In other words, the first contact portion C1 may be wider than the second contact portion C2. That is, the first pressing member 400 may be treated as a more important means for braking than the second braking member 600.

Meanwhile, the third pressing member 700 may be opposite to the second pressing member 600 with the brake disc 100 interposed therebetween, and operate independently from the first pressing member 400 to press the brake pad 300 toward the brake disc 100. The third pressing member 700 may be coaxial with the second pressing member 600.

According to an embodiment, as seen from FIGS. 2 and 3, the third pressing member 700 may be positioned to avoid the finger portion 510 of the housing 500. More specifically, as shown in FIG. 1, the first pressing member 400 may press a center portion of the inner brake pad 200, the second pressing member 600 may be biased in one direction with respect to the first pressing member 400, and the third pressing member 700 may be opposite to the second pressing member 600. That is, the first contact portion C1 and the second contact portion C2 may form an angle θ that is not zero with respect to a center O of the brake disc 100, and the angle θ that is not zero may need to be great enough for the third pressing member 700 to avoid the finger portion 510 of the housing 500.

Meanwhile, the outer brake pad 300 may include a third contact portion (not shown) that contacts the finger portion 510. The third contact portion may be a portion where a third pressure distribution is formed when the finger portion 510 contacts the outer brake pad 300. A shape of the third contact portion may correspond to a shape of the finger portion 510.

The outer brake pad 300 may include a fourth contact portion C4 that contacts the third pressing member 700. The fourth contact portion C4 may be a portion where a fourth pressure distribution is formed when the third pressing member 700 contacts the outer brake pad 300.

According to an embodiment, the fourth contact portion C4 may have a circular shape.

According to an embodiment, the second pressing member 600 may press a same area as the third pressing member 700. In other words, the third contact portion C3 and the fourth contact portion C4 may be congruent.

The housing 500 may include a first cylinder 522 in which the first pressing member 400 moves back and forth, a second cylinder 524 in which the second pressing member 600 moves back and forth, and a third cylinder 526 in which the third pressing member 700 moves back and forth.

According to an embodiment, the caliper brake 1000 may include a first motor (not shown), and a first nut (not shown) and a first spindle (not shown) for converting rotation motion of the first motor into linear motion of the first pressing member 400. In addition, the caliper brake 1000 may include a second motor (not shown), and a second nut (not shown) and a second spindle (not shown) for converting rotation motion of the second motor into linear motion of the second pressing member 600. In addition, the caliper brake 1000 may include a third motor (not shown), and a third nut (not shown) and a third spindle (not shown) for converting rotation motion of the third motor into linear motion of the third pressing member 700.

According to an embodiment, the housing 500 may be provided as one body and slide on the carrier (not shown) to move back and forth with respect to the carrier. That is, the first cylinder 522, the second cylinder 524, and the third cylinder 526 may move together in a state of being fixed to each other. In this case, while the first pressing member 400 moves forth, the second pressing member 600 and the third pressing member 700 may move back. Also, while the second pressing member 600 and the third pressing member 700 move forth, the first pressing member 400 may move back.

According to another embodiment, the housing 500 may include a first housing that slides on the carrier (not shown) to move back and forth with respect to the carrier, and a second housing that does not move relative to the carrier. The first cylinder 522 may be provided in the first housing, and the second cylinder 524 and the third cylinder 526 may be provided in the second housing.

The controller 800 may control operations of the first pressing member 400, the second pressing member 600, and the third pressing member 700.

According to an embodiment, the controller 800 may allow a contact of the second contact portion C2 only while the first contact portion C1 is spaced apart from the first pressing member 400. Also, the controller 800 may allow a contact of the first contact portion C1 only while the second contact portion C2 is spaced apart from the second pressing member 600. That is, according to a control by the controller 800, the first pressing member 400 and the second pressing member 600 may not press the inner brake pad 200 simultaneously. More specifically, the first pressing member 400 may press the inner brake pad 200 at high speed, and the second pressing member 600 may press the inner brake pad 200 at low speed. For example, when the vehicle is braked at low speed, for example, during city driving, the first pressing member 400 may be used, and when the vehicle is braked at high speed, for example, during highway driving, the second pressing member 600 (or the third pressing member 700) may be used.

As described above, the first pressing member 400 may press the inner brake pad 200 toward the brake disc 100. Also, the finger portion 510 of the housing 500 may press the outer brake pad 300 toward the brake disc 100 with a reaction force caused by a pressing force from the first pressing member 400. Also, the second pressing member 600 may neighbor the first pressing member 400, and operate independently from the first pressing member 400 to press the inner brake pad 200 toward the brake disc 100. Also, the third pressing member 700 may be opposite to the second pressing member 600 with the brake disc 100 interposed therebetween, and operate independently from the first pressing member 400 to press the outer brake pad 300 toward the brake disc 100. Accordingly, the caliper brake 1000 may selectively or simultaneously perform a first braking mode by the first pressing member 400 and the finger portion 510 and a second braking mode by the second pressing member 600 and the third pressing member 700. Accordingly, the caliper brake 1000 may adopt an advantageous mode between the first braking mode and the second braking mode according to a situation. For example, when the vehicle is braked at low speed, for example, during city driving, the first braking mode may be adopted, for example, to reduce noise, and when the vehicle is braked at high speed, for example, during highway driving, the second braking mode may be adopted, for example, to secure a great braking force.

That is, the caliper brake 1000 may have a more advantageous effect than existing techniques that implement only the first braking mode and existing other techniques that implement only the second braking mode.

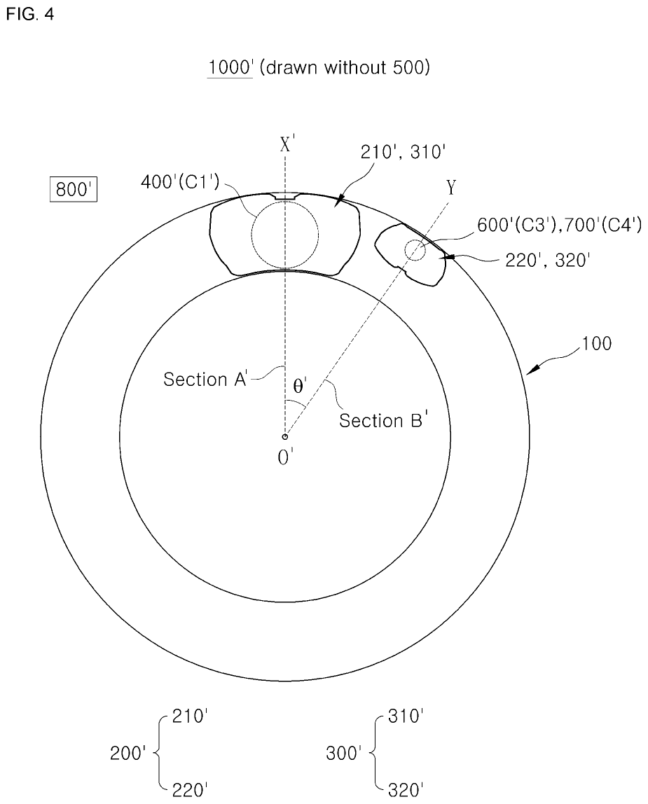

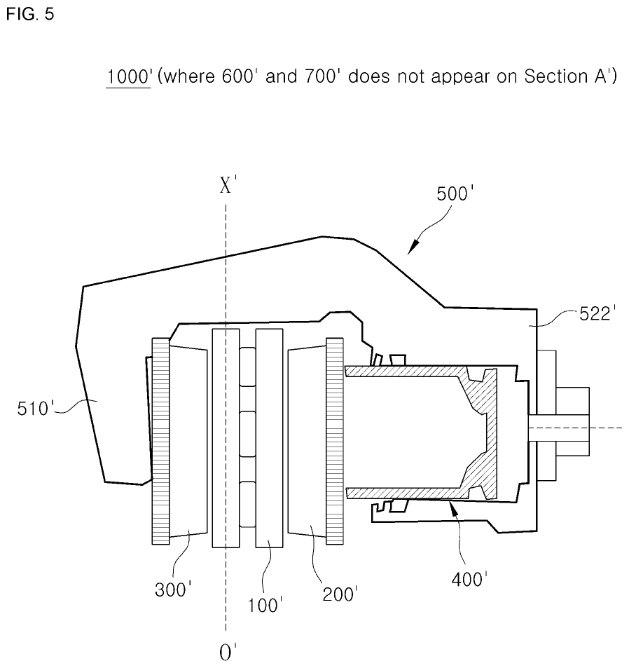

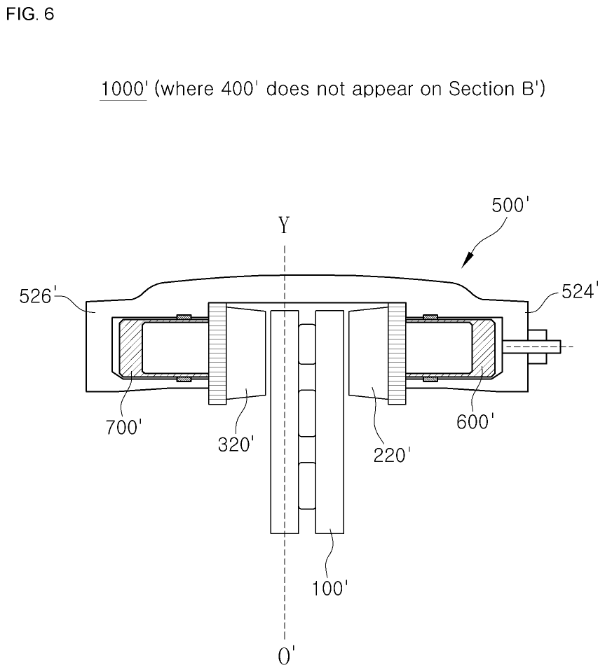

FIG. 4 is an orthographic projection view showing a caliper brake according to another embodiment when a housing is omitted, FIG. 5 is a cross-sectional view showing an example of a section A′, taken along line X′-O′ of FIG. 4, and FIG. 6 is a cross-sectional view showing an example of a section B′, taken along line Y′-O′ of FIG. 4.

Referring to FIGS. 4 to 6, a caliper brake 1000′ according to another embodiment may include the brake disc 100, an inner brake pad 200′, an outer brake pad 300′, a first pressing member 400′, a housing 500′, a second pressing member 600′, a third pressing member 700′, and a controller 800′.

The brake disc 100 may rotate together with a wheel (not shown).

The inner brake pad 200′ may be positioned to an inner side of the brake disc 100. The inner side of the brake disc 100 may mean an inner side of a vehicle in the caliper brake 1000′ is installed.

The inner brake pad 200′ may include a first inner brake pad 210′, and a second inner brake pad 220′ that is separated from the first inner brake pad 210′.

The first inner brake pad 210′ may be pressed toward the brake disc 100 by the first pressing member 400′, and the second inner brake pad 220′ may be pressed toward the brake disc 100 by the second pressing member 600′.

The outer brake pad 300′ may be positioned to an outer side of the brake disc 100. The outer side of the brake disc 100 may mean an outer side of the vehicle in which the caliper brake 1000′ is installed.

The outer brake pad 300′ may include a first outer brake pad 310′, and a second outer brake pad 320′ that is separated from the first outer brake pad 310′.

The first outer brake pad 310′ may be pressed toward the brake disc 100 by the finger portion 510′, and the second outer brake pad 320′ may be pressed toward the brake disc 100 by the third pressing member 700′.

The first pressing member 400′ may press the first inner brake pad 210′ toward the brake disc 100. The first inner brake pad 210′ may include a first contact portion C1′ that contacts the first pressing member 400′. The first contact portion C1′ may be a portion where a first pressure distribution is formed when the first pressing member 400′ contacts the first inner brake pad 210′.

According to an embodiment, the first contact portion C1′ may have a circular shape.

The housing 500′ may include a finger portion 510′. The finger portion 510′ may press the first outer brake pad 310′ toward the brake disc 100 with a reaction force caused by a pressing force from the first pressing member 400′. In this case, a carrier (not shown) may be provided in the caliper brake 1000′, and the housing 500′ may slide on the carrier to move back and forth with respect to the carrier. A method in which the housing 500′ moves back and forth with respect to the carrier has been widely known, and accordingly, detailed descriptions thereof will be omitted.

Meanwhile, the housing 500′ is not shown in FIG. 4. However, the housing 500′ will be sufficiently understood based on FIGS. 5 and 6.

The second pressing member 600′ may neighbor the first pressing member 400′ and operate independently from the first pressing member 400′ to press the second inner brake pad 220′ toward the brake disk 100. The second inner brake pad 220′ may include a second contact portion C2′ that contacts the second pressing member 400′. The second contact portion C2′ may be a portion where a second pressure distribution is formed when the second pressing member 600′ contacts the second inner brake pad 220′.

According to an embodiment, the second contact portion C2′ may have a circular shape.

According to an embodiment, the first pressing member 400′ may press a larger area than the second pressing member 600′. In other words, the first contact portion C1′ may be wider than the second contact portion C2′. That is, the first pressing member 400′ may be treated as a more important means for braking than the second braking member 600′.

Meanwhile, the third pressing member 700′ may be opposite to the second pressing member 600′ with the brake disc 100 interposed therebetween, and operate independently from the first pressing member 400′ to press the second outer brake pad 320′ toward the brake disc 100. The third pressing member 700′ may be coaxial with the second pressing member 600′.

According to an embodiment, as seen from FIGS. 5 and 6, the third pressing member 700′ may be positioned to avoid the finger portion 510′ of the housing 500′. More specifically, as shown in FIG. 4, the first pressing member 400′ may press a center portion of the first inner brake pad 210′, the second pressing member 600′ may be biased in one direction with respect to the first pressing member 400′, and the third pressing member 700′ may be opposite to the second pressing member 600′. That is, the first contact portion C1′ and the second contact portion C2′ may form an angle θ′ that is not zero with respect to the center O′ of the brake disc 100, and the angle θ′ that is not zero may need to be great enough for the third pressing member 700′ to avoid the finger portion 510′ of the housing 500′.

Meanwhile, the second outer brake pad 320′ may include a third contact portion (not shown) that contacts the finger portion 510′. The third contact portion may be a portion where a third pressure distribution is formed when the finger portion 510′ contacts the first outer brake pad 310′. A shape of the third contact portion may correspond to a shape of the finger portion 510′.

The second outer brake pad 320′ may include a fourth contact portion C4′ that contacts the third pressing member 700′. The fourth contact portion C4′ may be a portion where a fourth pressure distribution is formed when the third pressing member 700′ contacts the second outer brake pad 320′.

According to an embodiment, the fourth contact portion C4′ may have a circular shape.

According to an embodiment, the second pressing member 600′ may press a same area as the third pressing member 700′. In other words, the third contact portion C3′ and the fourth contact portion C4′ may be congruent.

The housing 500′ may include a first cylinder 522′ in which the first pressing member 400′ moves back and forth, a second cylinder 524′ in which the second pressing member 600′ moves back and forth, and a third cylinder 526′ in which the third pressing member 700′ moves back and forth.

According to an embodiment, the caliper brake 1000′ may include a first motor (not shown), and a first nut (not shown) and a first spindle (not shown) for converting rotation motion of the first motor into linear motion of the first pressing member 400′. In addition, the caliper brake 1000′ may include a second motor (not shown), and a second nut (not shown) and a second spindle (not shown) for converting rotation motion of the second motor into linear motion of the second pressing member 600′. In addition, the caliper brake 1000′ may include a third motor (not shown), and a third nut (not shown) and a third spindle (not shown) for converting rotation motion of the third motor into linear motion of the third pressing member 700′.

According to an embodiment, the housing 500′ may be provided as one body and slide on the carrier (not shown) to move back and forth with respect to the carrier. That is, the first cylinder 522′, the second cylinder 524′, and the third cylinder 526′ may move together in a state of being fixed to each other. In this case, while the first pressing member 400′ moves forth, the second pressing member 600′ and the third pressing member 700′ may move back. Also, while the second pressing member 600′ and the third pressing member 700′ move forth, the first pressing member 400′ may move back.

According to another embodiment, the housing 500′ may include a first housing that slides on the carrier (not shown) to move back and forth with respect to the carrier, and a second housing that does not move relative to the carrier. The first cylinder 522′ may be provided in the first housing, and the second cylinder 524′ and the third cylinder 526′ may be provided in the second housing.

The controller 800′ may control operations of the first pressing member 400′, the second pressing member 600′, and the third pressing member 700′.

According to an embodiment, the controller 800′ may allow a contact of the second contact portion C2′ only while the first contact portion C1′ is spaced apart from the first pressing member 400′. Also, the controller 800′ may allow a contact of the first contact portion C1′ only while the second contact portion C2′ is spaced apart from the second pressing member 600′. More specifically, the first pressing member 400′ may press the first inner brake pad 210′ at high speed, and the second pressing member 600′ may press the second inner brake pad 220′ at low speed. For example, when the vehicle is braked at low speed, for example, during city driving, the first pressing member 400′ may be used, and when the vehicle is braked at high speed, for example, during highway driving, the second pressing member 600′ (or the third pressing member 700′) may be used.

As described above, the first pressing member 400′ may press the first inner brake pad 210′ toward the brake disc 100. Also, the finger portion 510′ of the housing 500′ may press the first outer brake pad 310′ toward the brake disc 100 with a reaction force caused by a pressing force from the first pressing member 400′. Also, the second pressing member 600′ may neighbor the first pressing member 400′, and operate independently from the first pressing member 400′ to press the second inner brake pad 220′ toward the brake disc 100. Also, the third pressing member 700′ may be opposite to the second pressing member 600′ with the brake disc 100 interposed therebetween, and operate independently from the first pressing member 400′ to press the second outer brake pad 320′ toward the brake disc 100. Accordingly, the caliper brake 1000′ may selectively or simultaneously perform a first braking mode by the first pressing member 400′ and the finger portion 510′ and a second braking mode by the second pressing member 600′ and the third pressing member 700′. Accordingly, the caliper brake 1000′ may adopt an advantageous mode between the first braking mode and the second braking mode according to a situation. For example, when the vehicle is braked at low speed, for example, during city driving, the first braking mode may be adopted, for example, to reduce noise, and when the vehicle is braked at high speed, for example, during highway driving, the second braking mode may be adopted, for example, to secure a great braking force.

That is, the caliper brake 1000′ may have a more advantageous effect than existing techniques that implement only the first braking mode and existing other techniques that implement only the second braking mode.

The caliper brake according to the current embodiment may selectively or simultaneously perform the first braking mode by the first pressing member and the finger portion and the second braking mode by the second pressing member and the third pressing member.

The caliper brake according to the current embodiment may have a more advantageous effect than existing techniques that implement only the first braking mode.

The caliper brake according to the current embodiment may have a more advantageous effect than existing other techniques that implement only the second braking mode.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

What is claimed is:

1. A caliper brake comprising:
a brake disc configured to rotate together with a wheel;
an inner brake pad positioned to an inner side of the brake disc;
an outer brake pad positioned to an outer side of the brake disc;
a first pressing member configured to press the inner brake pad toward the brake disc;
a housing including a finger portion configured to press the outer brake pad toward the brake disc with a reaction force caused by a pressing force from the first pressing member;
a second pressing member neighboring the first pressing member and configured to operate independently from the first pressing member to press the inner brake pad toward the brake disc; and
a third pressing member being opposite to the second pressing member with the brake disc interposed therebetween and configured to operate independently from the first pressing member to press the outer brake pad toward the brake disc.

2. The caliper brake of claim 1, wherein the first pressing member presses a larger area than the second pressing member.

3. The caliper brake of claim 2, wherein the first pressing member presses a center portion of the inner brake pad.

4. The caliper brake of claim 3, wherein the second pressing member is biased in one direction with respect to the first pressing member.

5. The caliper brake of claim 1, wherein the second pressing member presses a same area as the third pressing member.

6. The caliper brake of claim 5, wherein the second pressing member is coaxial with the third pressing member.

7. The caliper brake of claim 1, wherein the housing includes a first cylinder in which the first pressing member moves back and forth, a second cylinder in which the second pressing member moves back and forth, and a third cylinder in which the third pressing member moves back and forth.

8. The caliper brake of claim 1, further comprising a controller configured to control operations of the first pressing member, the second pressing member, and the third pressing member.

9. The caliper brake of claim 1, wherein the inner brake pad includes a first inner brake pad and a second inner brake pad that is separated from the first inner brake pad, and
the outer brake pad includes a first outer brake pad and a second outer brake pad that is separated from the first outer brake pad.

10. The caliper brake of claim 9, wherein
the first inner brake pad is pressed toward the brake disc by the first pressing member, and
the second inner brake pad is pressed toward the brake disc by the second pressing member.

11. The caliper brake of claim 9, wherein
the first outer brake pad is pressed toward the brake disc by the finger portion, and
the second outer brake pad is pressed toward the brake disc by the third pressing member.
